(19) United States
(12) Patent Application Publication
(10) Pub. No.: US 2024/0294777 A1
(43) Pub. Date: Sep. 5, 2024

(54) COATING COMPOSITION

(71) Applicants: THE CHEMOURS COMPANY FC, LLC; CHEMOURS-MITSUI FLUOROPRODUCTS CO., LTD

(72) Inventors: HOAI-NAM PHAM, SHIZUOKA (JP); YUQING LIU, SHIZUOKA (JP)

(73) Assignees: THE CHEMOURS COMPANY FC, LLC, WILMINGTON, DE (US); CHEMOURS-MITSUI FLUOROPRODUCTS CO., LTD, TOKYO (JP)

(21) Appl. No.: 18/281,026

(22) PCT Filed: Mar. 7, 2022
(86) PCT No.: PCT/US2022/019100

§ 371 Date: Sep. 8, 2023

(30) Foreign Application Priority Data
Mar. 8, 2021 (JP) 2021-036511

(51) Int. Cl. C09D 5/16; C08J 7/04; C09D 7/63; C09D 7/65; C09D 115/00; C09D 127/18; C09D 127/20; C09D 129/10; C09D 183/04

(52) U.S. Cl. CPC C09D 5/1668; C08J 7/0427; C09D 5/1675; C09D 7/63; C09D 7/65; C09D 115/005; C09D 127/18; C09D 127/20; C09D 129/10; C09D 183/04; C08J 2415/00; C08J 2427/18; C08J 2427/20; C08J 2429/10; C08J 2483/04

(57) ABSTRACT

Provided is a coating composition capable of forming a coating film capable of maintaining excellent tack-free properties (releasability) for a long period of time on a plastic substrate or a rubber substrate, and particularly an elastic substrate made of rubber. The coating composition contains a rubber and an oil that is a liquid at 25° C., wherein the oil is dispersed at an average particle diameter of 50 μm or less.

### CROSS REFERENCE TO RELATED APPLICATIONS

This application is a national filing under 35 U.S.C. 371 of International Application No. PCT/US2022/019100 filed Mar. 7, 2022 and claims the benefit of priority of Japanese Application No. 2021-036511 filed Mar. 8, 2021, the disclosure of which is incorporated herein by reference in its entirety.

### TECHNICAL FIELD

The present invention relates to a coating composition, and more particularly relates to a coating composition that can be applied to a substrate having inferior heat resistance such as rubber or plastic, and can form a coating film with excellent durability in which anti-sticking properties (releasability) of the coating film can be maintained over a long period of time.

### BACKGROUND TECHNOLOGY

A mold for molding a polymer material such as a plastic material, rubber material, or ceramic, cement, or the like, requires mold surface releasability in order to remove a molded product without defects. As a coating composition capable of forming a coating film for improving mold surface releasability, the present inventors proposed a coating composition containing a fluorine resin and a specific oil (Patent Documents 1 and 2). A mold having a coating film made of the coating composition on a surface also has excellent durability that enables excellent releasability to be expressed over a long period of time. However, such coating is not suitable for a resin substrate that cannot withstand heat treatment for forming a coating film, or a substrate having elasticity such as rubber or the like.

On the other hand, a coating composition that can provide mold releasability that can withstand long-term use is required on resin or rubber substrates. For example, when molding a tire, a member mainly made of rubber called a bladder is generally used to press a rubber composition that will form the tire from an inner side of a mold, and there is a need for a coating that can form a coating film with high durability and high releasability on a bladder surface. Furthermore, when molding a rubber shoe sole, use of a resin mold for injection molding is common in order to easily accommodate design changes, and releasability is also required in resin molds when removing a rubber molded product from the resin mold.

As a tack-free composition that can be used as an anti-blocking agent for synthetic resins and vulcanized or unvulcanized rubbers, the following Patent Document 3 describes a tack-free composition containing: (A) a compound having a perfluoroalkyl or alkenyl group having 4 to 20 carbon atoms; (B) polytetrafluoroethylene having a number average molecular weight of 500,000 or less; and (C) at least one type of compound selected from a group consisting of silicone oils, silicone resins, and highly fluorinated compounds having a boiling point of 100° C. or higher expressed by general formula: CF2CFCln (where n=2 to 15) or the like (excluding those included in the components (A) and (B)).

Furthermore, as a method of improving the releasability (lubricity) of a bladder surface used for tire molding, the following Patent Document 4 describes a method of coating an outer surface of a bladder with a release agent composition in the form of an oil-in-water emulsion containing reactive polyorganosiloxane, a crosslinking agent, non-reactive linear polyorganosiloxane oil, glass beads, surfactant, additives, and the like.

### PRIOR ART DOCUMENTS

### Patent Documents

### Patent Document 1: Japanese Unexamined Patent Application 2018-90772

Patent Document 2: Japanese Unexamined Patent Application 2019-203087
Patent Document 3: Japanese Patent No. 3348433
Patent Document 4: Japanese Patent No. 6255604

### SUMMARY OF THE INVENTION

### Problem to be Resolved by the Invention

The composition described in Patent Document 3 above is used as an anti-blocking agent for synthetic resins and vulcanized or unvulcanized rubbers, but the composition may not be durable enough to provide excellent releasability over a long period of time in products such as bladders that are repeatedly expanded (stretched) and contracted (shrunk).

Furthermore, applying the release agent composition described in Patent Document 4 enables an increased number of release operations, in other words, improved durability, but in a specific embodiment thereof, the number of release operations is at most 18 times, which is not sufficient. Furthermore, glass beads with an average particle diameter of up to 150 μm are added in order to increase the number of release operations, but when applied to a resin mold used for injection molding, unevenness caused by the glass beads may be transferred to a surface of the molded product, and thus a smooth surface may not be obtained.

Therefore, an object of the present invention is to provide a coating composition capable of forming a coating film that can express excellent releasability over a long period of time without causing the aforementioned problems, for a substrate having inferior heat resistance such as rubber or plastic substrates.

Another object of the present invention is to provide: a coating composition capable of forming a coating film that can also track stretching/shrinking of a substrate having stretchability, such as a rubber bladder or the like used in tire manufacturing, as well as a rubber or plastic substrate having the coating film.

### Means for Resolving Problems

The present invention provides a coating composition, containing: a rubber; and an oil that is a liquid at 25° C., wherein the oil is dispersed with an average particle diameter of 50 μm or less.

In the coating composition of the present invention, it is preferable that:
(1) fluorine resin particles are included;
(2) a silane coupling agent is included;
(3) the oil is included at an amount of 1 to 35 wt. % of the amount (solid fraction) of rubber, or the total amount (solid fraction) of rubber and fluorine resin particles in the coating composition;
(4) the rubber is included at an amount of 40 wt. % or more of the total amount (solid fraction) of rubber and fluorine resin particles in the coating composition;
(5) the rubber is a hydrogenated acrylonitrile butadiene rubber or silicone rubber;
(6) the oil is a fluoro oil or silicone oil;
(7) the fluorine resin particles are made of melt-processable fluorine resin; and
(8) the fluorine resin particles comprise PFA or FEP.

The present invention also provides a rubber or plastic substrate having a coating film made of the aforementioned coating composition on a surface.

In the rubber or plastic substrate of the present invention, the n-hexadecane contact angle of the coating film is preferably 50 degrees or more.

### Effect of the Invention

The coating composition of the present invention can form a coating film having excellent durability capable of expressing excellent tack-free properties (releasability) over a long period of time, not only on a heat-resistant substrate such as an aluminum substrate, but also on a substrate having inferior heat resistance such as a substrate made of rubber or plastic. Furthermore, a coating film can be formed with excellent trackability on an elastic substrate such as a rubber substrate.

Furthermore, in the coating composition, the oil is present in a condition dispersed at an average particle diameter of 50 μm or less, and is present in a condition dispersed inside a formed coating film. Therefore, even when the coating film is worn due to use, the oil inside the coating film gradually exudes to the surface, and thus high tack-free properties (releasability) can be expressed over a long period of time.

Furthermore, the rubber or plastic substrate, such as a bladder, resin mold, or the like, having a coating film made of the coating composition of the present invention has excellent releasability of a molded product, and thus has excellent moldability and productivity since the releasability is maintained over a long period of time.

### DESCRIPTION OF THE PREFERRED EMBODIMENTS

### Coating Composition

Important features of the coating composition of the present invention are that the coating composition contains a rubber and an oil that is a liquid at 25° C., and the oil is dispersed at an average particle diameter of 50 μm or less.

In the coating composition of the present invention, oil, which is in a fluid state at 25° C. (ambient temperature), exudes on a surface of a formed coating film to provide releasability to a substrate, and use of rubber as a base resin of the coating composition enables the formed coating film with excellent adhesion with a rubber substrate or a plastic substrate and enables the coating film to follow the expansion and contraction of the rubber substrate, therefore, the occurrence of cracks and the like are effectively prevented, and excellent releasability can be provided to the rubber substrate over a long period of time.

Furthermore, in the present invention, rubber used as a base resin is used in an unvulcanized condition and is vulcanized when forming the coating film. The vulcanization treatment temperature can be 200° C. or lower (and preferably 180° C. or lower). Therefore, the coating composition of the present invention can be used without any problem on a plastic or rubber substrate that can be used at or above the temperature.

In the coating composition of the present invention, including oil improves tack-free properties (releasability) of the coating film due to the oil being exuded on a surface of the coating film. Furthermore, the oil reduces friction, which in turn reduces the coefficient of friction of the coating film (improves slipping properties), and thus improves wear resistance of the coating film. Furthermore, in the present invention, the oil is present in a condition dispersed at an average particle diameter of 50 μm or less in the coating composition, and therefore, the oil is also present in a dispersed condition inside the formed coating film. Therefore, when the coating film is worn due to use, the oil inside the coating film gradually exudes to a surface thereof, and thus a high level of tack-free properties (releasability) can be expressed over a long period of time. The average particle diameter of the dispersed particles of the oil in the coating composition is 50 μm or less, preferably 20 μm or less, more preferably 10 μm or less, and particularly preferably 5 μm or less. Note that the method for measuring the average particle diameter will be described later.

So long as the coating composition of the present invention contains a combination of rubber and oil as described above, the composition may have any form such as a water based coating composition, solvent based coating composition, or powder coating composition, but is preferably a water based coating composition or powder coating composition, from the perspective of environment and cost.

### Rubber

Rubber used as a base resin in the coating composition of the present invention can be any natural rubber or synthetic rubber.

Specific examples of synthetic rubbers include silicone rubbers, acrylic rubbers, isoprene rubbers (IR), urethane rubbers, ethylene vinyl acetate rubbers (EVA), epichlorohydrin rubbers, ethylene propylene diene rubbers (EPDM), chloroprene rubbers (CR), chlorosulfonated polyethylene (CSM), styrene-butadiene rubbers (SBR), thiokols, butyl rubbers (IIR), butadiene rubbers (BR), acrylonitrile butadiene rubbers (NBR), ethylene propylene rubbers (EPR), fluororubbers, and other conventionally known synthetic rubbers.

In the present invention, hydrogenated acrylonitrile butadiene rubber (HNBR) and silicone rubber can be preferably used from the perspective of providing heat resistance, durability after vulcanization, adhesion to a substrate or releasability, and maintaining an elongation percentage of 50% or more even after the coating film is formed.

The hydrogenated acrylonitrile butadiene rubber (HNBR) may be either partially or fully hydrogenated, and the amount of acrylonitrile is preferably within a range of 10 to 50 wt. %. Furthermore, the Mooney viscosity ML (1+4) at 100° C. (in accordance with JIS K6300) is preferably within a range of 30 to 150.

As the silicone rubber, any conventionally known silicone rubber can be used, and although not a limitation, methyl silicone rubber, vinyl methyl silicone rubber, phenyl methyl silicone rubber, and the like can be preferably used.

Adhesion of the coating film can be further improved by using the same rubber component in the coating composition as a substrate to which the coating composition is applied. In other words, a silicone rubber is preferably used as a rubber in the coating composition for a substrate made of silicone rubber, and a hydrogenated acrylonitrile butadiene rubber (HNBR) is preferably used for a substrate made of a hydrocarbon rubber such as butyl rubber (IIR), acrylonitrile butadiene rubber (NBR), or the like.

In the coating composition of the present invention, the rubber serving as the base resin is preferably included in the coating composition at an amount of 10 to 50 wt. % based on solid fraction.

Furthermore, even when fluorine resin particles are included, the amount of rubber in the entire base resin (total amount of solid fraction of rubber and fluorine resin particles) is preferably 40% or more, and particularly preferably 50% or more. Thereby, a coating film can be formed at the low temperature described above, and a coating film having excellent tack-free properties (releasability) can be formed with favorable adhesion without degrading the plastic or rubber substrate.

### Oil

A liquid oil at 25° C. used in the coating composition of the present invention exhibits fluidity at ambient temperature (25° C.), and various oils can be used so long as this condition is satisfied. However, as described above, a purpose of the oil is to exude to the surface of the formed coating film to improve the tack-free properties (releasability) of the coating film, therefore, the oil itself preferably has low surface tension. In other words, the surface tension of the oil at 25° C. is preferably 30 mN/m or less, and more preferably 20 mN/m or less. Furthermore, it is preferable to have heat resistance to withstand heating during crosslinking of the rubber and to not volatilize under the heating, and thus a decomposition (volatilization) temperature is preferably 200° C. or higher.

In order to satisfy the conditions, the oil must have excellent heat resistance and small intermolecular interactions. Examples of the oil can include fluoro oils, silicone oils, modified silicone oils, alkanes with 15 to 100 carbon atoms, higher fatty acids with 5 to 50 carbon atoms, fatty acid esters, hydrocarbon based oils such as polyol esters, polyglycols, polyethers, polyphenyl ethers, and the like. While these can be used alone or in combination, in the present invention, a fluoro oil or silicone oil can be preferably used.

Exemplary fluoro oils include, but are not limited to, perfluoropolyethers (PFPE), perfluoroalkyl polyethers, and telomers of fluorinated monomers (for example, tetrafluoroethylenes (TFE), ethylene trifluorides, vinylidene fluorides, chlorotetrafluoroethylenes (CTFE), fluorinated acrylic monomers, etc.), other specific fluorinated hydrocarbon compounds, etc.

PFPE having low surface energy and capable of efficiently enhancing the tack-free properties (releasability) of the coating film can be suitably used in the present invention, and can be procured as products going by the commercial names of Krytox® (manufactured by The Chemours Company) or DEMNUM® (manufactured by Daikin Industries, Ltd.), or the like.

Exemplary silicone oils include, but are not limited to, straight silicone oils such as dimethyl silicone oils, methyl phenyl silicone oils, and methyl hydrogen silicone oils, reactive modified silicone oils such as monoamine modified silicone oils, diamine modified silicone oils, amino modified silicone oils, epoxy-modified silicone oils, alicyclic epoxy-modified silicone oils, carbinol-modified silicone oils, mercapto-modified silicone oils, carboxyl-modified silicone oils, hydrogen-modified silicone oils, amino polyether-modified silicone oils, epoxy polyether-modified silicone oils, and epoxy aralkyl-modified silicone oils, and non-reactive modified silicone oils such as polyether-modified silicone oils, aralkyl-modified silicone oils, phloroalkyl-modified silicone oils, halogen-modified silicone oils, long chain alkyl-modified silicone oils, higher fatty acid ester-modified silicone oils, higher fatty acid amide-modified silicone oils, polyether long chain alkyl aralkyl-modified silicone oils, long chain alkyl aralkyl-modified silicone oils, and the like. Among these, methyl phenyl silicone oils that can also be used in food applications can be suitably used.

The oil is preferably included at an amount of 1 to 35 wt. %, preferably 2 to 20 wt. %, and more preferably 5 to 10 wt. % based on the solid fraction amount of the base resin (rubber, or the total of rubber and fluorine resin particles if fluorine resin particles are included) in the coating composition. If the amount of oil is less than the aforementioned range, the tack-free properties (releasability) of the coating film may not be sufficiently improved as compared to when the amount of oil is within the aforementioned range. On the other hand, if the amount of oil is higher than the aforementioned range, a coating film may be more difficult as compared to when the amount of oil is in the aforementioned range. Thus, coating film defects may occur, and wear resistance may be impaired.

### Fluorine Resin Particles

The coating composition of the present invention preferably further contains fluorine resin particles. In other words, when fluorine resin particles are included, the surface energy of the coating film is reduced, further improving the slipping properties and the tack-free properties (releasability) of the coating film. Furthermore, wear resistance is also improved by reducing the coefficient of friction. Thus, the tack-free properties (releasability) is maintained over a long period of time, and therefore, the durability is also improved.

Furthermore, as will be described later, when baking is performed at a temperature of approximately 180° C. when forming the coating film, the fluorine resin particles do not melt in the formed coating film, and the fluorine resin particles form a sea-island structure where the fluorine resin particles become islands in a matrix (sea) made of rubber. Thus, the elasticity of the coating film made of rubber is not impaired.

Examples of the fluorine resin particles include, but are not limited to, fluorine resin particles made of polytetrafluoroethylenes (PTFE), tetrafluoroethylene perfluoro (alkyl vinyl ether) copolymers (PFA), tetrafluoroethylene hexafluoropropylene copolymers (FEP), tetrafluoroethylene hexafluoropropylene perfluoro (alkyl vinyl ether) copolymers, tetrafluoroethylene ethylene copolymers, polyvinylidene fluorides, polychlorotrifluoroethylenes, chlorotrifluoroethylene ethylene copolymers, and the like.

Of the aforementioned fluorine resin particles, melt-processable fluorine resin particles are preferably used, and from the perspective of tack-free properties and heat resistance of a coating film, a melt-processable perfluoro resin, such as a low molecular weight PTFE, PFA, FEP, or a tetrafluoroethylene hexafluoropropylene perfluoro (alkyl vinyl ether) copolymer can be preferably used. PFA can be more preferably used.

The alkyl group of the perfluoro (alkyl vinyl ether) in the PFA preferably has 1 to 5 carbon atoms, wherein among these, perfluoro (propyl vinyl ether) (PPVE), perfluoro (ethyl vinyl ether) (PEVE), and perfluoro (methyl vinyl ether) (PMVE) are particularly preferable. The amount of perfluoro (alkyl vinyl ether) in the PFA is preferably in a range of 1 to 50 wt %.

Although the fluorine resin particles can be used as powder particles of fluorine resin, the fluorine resin particles are preferably finely dispersed in the coating film to achieve excellent releasability. Therefore, the dispersion obtained by emulsion polymerization is preferably added and used as a raw material for a coating. The average particle diameter of the fluorine resin particles is preferably 0.5 μm or less, and particularly preferably 0.3 μm or less.

For the fluorine resin configuring the fluorine resin particles, a high molecular weight PTFE that does not exhibit melt fluidity (i.e., is not melt processable) even at or above the melting point can be used along with the aforementioned melt-processable perfluoro resin. Particles of the high molecular weight PTFE also act as fillers, which can improve the durability of the coating film while also improving the releasability.

A PTFE aqueous dispersion obtained by emulsion polymerization is preferably used as such PTFE.

The fluorine resin particles is preferably included at an amount of 10 wt. % or more, preferably 20 to 60 wt. %, and more preferably 30 to 50 wt. % of the entire base resin (total weight of rubber and fluorine resin particles) included in the coating composition. If the amount of the fluorine resin particles is less than the aforementioned range, the effect of including the fluorine resin particles described above cannot be sufficiently achieved. On the other hand, if the amount of the fluorine resin particles is greater than the aforementioned range, the coating film may become too soft, and thus the wear resistance may be reduced, as compared to when in the aforementioned range.

### Silane Coupling Agent

In the coating composition of the present invention, a silane coupling agent is preferably included in order to improve adhesion between the coating film and the plastic substrate or rubber substrate. In particular, when a silicone rubber is used, adhesion of the coating film to the rubber substrate is further improved.

Conventionally known silane coupling agents can be used as the silane coupling agent that can be used in the coating composition of the present invention, and examples can include, but are not limited to, γ-(2-aminoethyl) aminopropyltrimethoxysilane, γ-aminopropyltriethoxysilane, N-β (aminoethyl) γ-aminopropyltrimethoxysilane, N-β (aminoethyl) γ-aminopropylmethyldimethoxysilane, and other silane coupling agents containing an amino group; γ-glycidoxypropyltrimethoxysilane, γ-glycidoxypropylmethyldimethoxysilane, and other silane coupling agents containing a glycidyl group; γ-mercaptopropyltrimethoxysilane and other silane coupling agents containing a mercapto group; vinyltriethoxysilane, vinyltrimethoxysilane, vinyltris(methoxyethoxy)silane, and other silane coupling agents containing a vinyl group; γ-(meth)acryloyloxypropyltrimethoxysilane, γ-(meth)acryloyloxypropyltriethoxysilane, γ-(meth)acryloyloxypropyldimethoxymethylsilane, and other silane coupling agents containing a (meth)acryloyl group; γ-isocyanate propyltriethoxysilane, γ-isocyanate propyltrimethoxysilane, and other silane coupling agents containing an isocyanate group; and the like.

The silane coupling agent is preferably mixed at an amount of 0.5 to 3.0 wt. %, and particularly 0.8 to 2.5 wt. % based on the solid fraction amount of the entire base resin (rubber, or the total of rubber and fluorine resin particles if fluorine resin particles are included) in the coating composition. If the amount of the silane coupling agent is less than the aforementioned range, the aforementioned effect obtained by mixing the silane coupling agent cannot be sufficiently achieved. On the other hand, if the amount of silane coupling agent is higher than the aforementioned range, the tack-free properties (releasability) of the coating film may be impaired as compared to when in the aforementioned range.

### Preparation of the Coating Composition

As described above, the coating composition of the present invention is preferably a water based coating composition. Moreover, although not a limitation, preparation of the water based coating composition can include the following preparation methods.

When the coating composition of the present invention is prepared as a water based coating composition, the coating composition can be prepared by a method of mixing an aqueous dispersion of rubber (latex) or a precursor solution of rubber, prepared by a conventionally known method, oil (preferably dispersed in a liquid medium in advance), an aqueous dispersion of fluorine resin particles included if necessary or a mixed liquid thereof (for example, an existing fluorine resin water based coating or the like), a silane coupling agent, or another additive described later.

The aqueous dispersion of rubber can be prepared by a conventionally known method, and can be prepared by, but not limited to, emulsion polymerization, suspension polymerization, a method using an emulsifying device such as a high-speed homogenizer or the like, an inversion emulsification method, a phase inversion temperature emulsification method, and an emulsification method using a surfactant, or the like.

In the aqueous dispersion of rubber, rubber particles having an average particle diameter of 0.01 to 0.5 μm are preferably dispersed to be 10 to 70 wt. % in the aqueous dispersion.

The aqueous dispersion of fluorine resin particles used in the coating composition can be prepared by dispersing the fluorine resin uniformly and stably in an aqueous solution using a surfactant or the like, or by water based emulsion polymerizing the fluorine resin using a surfactant and an initiator, or, if necessary, a chain transfer agent or the like.

In the fluorine resin aqueous dispersion, the fluorine resin particles having an average particle diameter of 0.01 to 180 μm are preferably dispersed to be 10 to 70 wt. % in the aqueous dispersion.

In the coating composition of the present invention, the aqueous dispersion of the aforementioned rubber and an aqueous dispersion of fluorine resin included if necessary may be used as is, but a filler and various additives used in an ordinary coating may be added in accordance with required characteristics, such as dispersibility, conductivity, foaming prevention, wear resistance improvement, and the like.

Examples can include surfactants (examples thereof include polyoxyethylene alkyl ether, polyoxyethylene alkyl phenyl ether type nonionic surfactants; such as LIOCOL® manufactured by LION, Inc., the TRITON® and TERGITOL® series manufactured by the Dow Chemical Company, and EMALGEN® manufactured by KAO, Inc., sulfosuccinates; such as REPAL® manufactured by LION, Inc., EMAL®, PELEX®, and the like, manufactured by KAO, Inc.; polycarboxylate, acrylic salt type polymer surfactants, such as alkyl ether sulfonic acid sodium salts, sulfate mono-long chain alkyl based anionic surfactants, LEOAL® manufactured by LION, Inc., OROTAN® manufactured by the Dow Chemical Company, and the like), film forming agents (examples include polymeric film forming agents such as polyamides, polyamide imides, acrylics, acetates, and the like; higher alcohols and ethers; polymeric surfactants having a film forming effect, and the like), and thickeners (examples include soluble celluloses, solvent dispersion thickeners, sodium alginates, caseins, sodium caseinates, xanthan gums, polyacrylic acids, and acrylic esters), and the like.

### Aqueous Coating Composition

The water based coating composition of the present invention can be prepared by adding the oil such that the amount is 1 to 35 wt. %, preferably 2 to 20 wt. %, and more preferably 5 to 10 wt. % with regard to a solid fraction amount of the base resin (rubber, or the total of rubber and fluorine resin particles when fluorine resin particles are included) in the coating composition to the aqueous dispersion of rubber, the aqueous dispersion of fluorine resin particles, or an water based composition thereof prepared by the method described above, and then adding and stirring.

In the coating composition of the present invention, it is important that the oil is finely dispersed in the coating composition in order to form a coating film with excellent smoothness and without defects such as mottling and the like. It is also important for the oil to be dispersed in the coating film formed by the finely dispersed oil, and for the oil to exude to the surface of the coating film over a long period of time to express high tack-free properties (releasability).

From this perspective, the oil is preferably dispersed in the coating composition at an average particle diameter of 50 μm or less, and particularly preferably 20 μm or less. The oil can be used independently, but is preferably used in combination with a surfactant to finely disperse the oil.

Conventionally known surfactants can be used as the surfactant used to improve oil dispersibility.

In the present invention, when fluoro oil is used, the fluoro oil can be highly dispersed by using a surfactant having excellent affinity with the fluoro oil, and therefore, a fluorine based surfactant (having a fluorocarbon structure as a hydrophobic group) is preferably used.

Specific examples of fluorine based surfactants include the Capstone® series (manufactured by The Chemours Company), the MEGAFACE series (manufactured by DIC Corporation), Ftergent (manufactured by NEOS Company Limited), and the like.

In the present invention, when silicone oil is used, the silicone oil can be highly dispersed by using a surfactant having excellent affinity with the silicone oil, therefore, a silicone based surfactant (having a silicon structure as a hydrophobic group) is preferably used. Note that when the silicone oil is used and the silane coupling agent is added, addition is preferably performed immediately before coating to promote crosslinking of silicone.

Examples of silicone surfactants include polyoxyethylene (POE)-modified organopolysiloxane, polyoxyethylene/polyoxypropylene (POE/POP)-modified organopolysiloxane, POE sorbitan-modified organopolysiloxane, POE glyceryl-modified organopolysiloxane, other organopolysiloxanes modified with a hydrophilic group, and the like.

Specific examples include DBE-712, DBE-821 (manufactured by AZmax Co., Ltd.), KF-6015, KF-6016, KF-6017, KF-6028 (manufactured by Shin-Etsu Chemical Co., Ltd.), ABIL-EM97 (manufactured by Goldschmidt), Polyflow KL-100, Polyflow KL-401, Polyflow KL-402, Polyflow KL-700 (manufactured by Kyoeisha Chemical Co., Ltd.), and the like.

The surfactant is preferably added at an amount of 1 to 200 weight parts, and more preferably 5 to 100 weight parts with regard to 100 weight parts of the oil.

Furthermore, when using the aforementioned surfactant, the oil can be diluted with a fluorinated solvent or other solvent to reduce the viscosity, such that the oil can be made into a finely dispersed dispersion when mixed and stirred with water or an aqueous rubber dispersion, or a mixed liquid of an aqueous rubber dispersion and an aqueous fluorine resin dispersion.

Examples of the fluorinated solvent that can be used to dilute the oil include hydrofluorocarbons (HFC), perfluorocarbons (PFC), hydrochlorofluorocarbons (HCFC), chlorofluorocarbons (CFC), hydrofluoroolefins (HFO), hydrochlorofluoroolefins (HCFO), hydrofluoroethers (HFE), and other fluorinated solvents.

The solvent is preferably added at an amount of 100 to 500 weight parts with regard to 100 weight parts of the oil.

Furthermore, so that the oil is well dispersed, the oil is preferably dispersed using ultrasonic dispersion or a high shear rate in conjunction with using the abovementioned surfactant. A commonly used ultrasonic disperser, stirrer, or a variety of homogenizers (high pressure, high speed, ultrasonic, etc.) can be used for these dispersions. Through the use thereof, the oil can be finely dispersed without being diluted using a solvent, which is preferable from the perspective of simplifying the process and reducing costs related to the use of the fluorinated solvent. Furthermore, the abovementioned dispersion also can be carried out after the oil has been diluted with the solvent, with better dispersion expected as a result of doing so.

### Solvent Based Coating Composition

Furthermore, a solvent based coating composition can be prepared by preparing a liquid rubber, a rubber solvent dispersion, a fluorine resin solution, or a fluorine resin solvent dispersion, then adding an oil, and preferably a dispersion of the aforementioned oil, thereto at an amount of 1 to 35 wt. % of the base resin solid fraction (total weight of the rubber and, if necessary, the fluorine resin particles included in the coating composition) in the coating composition, and then stirring and mixing.

### Powder Coating Composition

For a powder coating composition, an oil, and preferably the oil dispersion described above, is added to the aqueous dispersion of the rubber and the fluorine resin aqueous dispersion prepared by the method described above at an amount of 1 to 35 wt. % of the resin solid fraction (total weight of the rubber and, if necessary, the fluorine resin included in the coating composition) in the coating composition, and then stirred to coaggregate the rubber, fluorine resin, and oil. After granulating the aggregated granules by stirring the granules for 10 to 60 minutes at a stirring speed of 100 to 500 rpm such that average particle diameter is 1 to 200 μm, the oil is made—through separating, washing, and drying—to fill voids in primary particles of the rubber/fluorine resin, and thus a composite powder of the rubber/fluorine resin and the oil in which the oil is uniformly present can be prepared. Large coarse particles with particle diameters of at least 200 μm generated by aggregation or over-granulation can be crushed into fine particles as necessary.

Note that an electrolytic material, such as HCl, H2SO4, HNO3, H3PO4, Na2SO4, MgCl2, CaCl2, HCOONa, CH3COOK, (NH4)2CO3, or the like is preferably added to chemically aggregate rubber/fluorine resin primary particles. Additionally, an organic solvent incompatible with water (preferably a fluorinated solvent) is preferably added as needed so as to uniformly granulate the aggregated particles.

### Other

A variety of organic and inorganic fillers can be added to the coating composition according to the present invention, based on the characteristics required thereof. Examples of organic fillers include engineering plastics, such as polyarylene sulfides, polyether ether ketones, polyamides, polyimides, and the like. Exemplary inorganic fillers include metal powders, metal oxides (aluminum oxide, zinc oxide, tin oxide, titanium oxide, etc.), glass, ceramics, silicon carbides, silicon oxides, calcium fluorides, carbon black, graphites, micas, barium sulfates, etc. Fillers having a variety of shapes, such as particle shaped, fiber shaped, flaked shaped fillers, and the like, can be used as the shape of the filler.

Furthermore, in addition to the above, a pigment and various additives conventionally used in coatings can be added in accordance with required characteristics, such as electrical conductivity, foam prevention, improved wear resistance, and the like.

Using these fillers not only provides various characteristics to the coating film, but also provides fine unevenness to a surface of a mating material (molded product) when the coating composition of the present invention is coated on a mold for molding, thereby suppressing gloss.

As described above, while wear resistance is enhanced by the presence of oil in the coating composition of the present invention, wear resistance is further enhanced by adding the filler. Examples of particularly preferable fillers include, but are not limited to, silicon carbides (SiC), silicas, and polyimides (PI).

While the added amount of the filler depends on the filler used and thus cannot be specified definitively, the amount is preferably within a range of 0.1 to 10 wt. % based on the coating solid fraction (the entire solid fraction remaining as the coating film excluding the oil, in other words, the total amount of the rubber, fluorine resin, and the filler) of the coating composition. When the amount of added filler is below this range, the enhancement of wear resistance due to the added filler becomes poorer, meanwhile, when the amount is above this range, releasability is lower than when compared to a case where the amount is in this range.

When the coating composition is a liquid coating such as a water based coating, etc., the filler can be used by dispersing the filler in a liquid medium such as water or the like.

### Coating Method

The coating composition of the present invention can be coated by a conventionally known coating method such as spray coating, dip coating, and the like.

After coating, the coated coating composition is heat treated to the crosslinking temperature of the rubber to form a coating film. As described above, in the coating composition of the present invention, the crosslinking temperature of the rubber is as low as 120 to 200° C. Therefore, even if the coating is applied directly to a plastic or rubber substrate and heat treated, a uniform coating film can be formed without damaging the substrate.

Note that heating conditions (baking conditions) of the coating composition of the present invention vary depending on the composition and form of the coating composition, the amount of coating, the desired crosslinking temperature, and the like, and thus cannot be generally specified. However, the coating composition is preferably heated at a temperature higher than the crosslinking temperature of the used rubber for 5 to 120 minutes. Furthermore, crosslinking can be accelerated by performing the heat treatment a plurality of times, and wear resistance can also be improved.

Furthermore, the coating composition of the present invention has excellent adhesion to plastic and rubber substrates, and therefore can be coated directly onto a substrate surface without requiring a primer layer, surface treatment of the substrate, and the like.

### Plastic Substrate or Rubber Substrate

As described above, the coating film can be formed at a low temperature, therefore, the coating composition of the present invention can be applied to a substrate having inferior heat resistance, and can be preferably used on plastic or rubber substrates. Specifically, the coating composition can be used on conventional known polymer materials, such as resins or resin compositions such as thermoplastic resins, thermosetting resins, photocurable resins, electron beam curable resins, and the like, as well as on rubbers, thermoplastic elastomers, and the like.

The coating film is made of the coating composition of the present invention and has a property of being able to follow expansion and contraction of a substrate, and therefore, can be particularly preferably used on rubber substrates having elasticity of the substrates described above.

Examples of thermoplastic resins that can configure the substrate include, but are not limited to, polyethylene, polypropylene, and other olefin resins, polyethylene terephthalate, polybutylene terephthalate, and other polyester resins, polymethyl methacrylate and other acrylic resins, polycarbonate, polyimide, polyamide resins, and the like.

Furthermore, examples of thermosetting resins include, but are not limited to, phenol resins, epoxy resins, melamine resins, unsaturated polyester resins, silicone resins, and the like.

Exemplary photocurable resins include, but are not limited to, 1 to 2 functional monomers having one or more (meth) acryloyl groups per molecule, acrylic resins consisting of multifunctional monomers, multifunctional oligomers, or multifunctional polymers. Exemplary electron beam curing resins include, but are not limited to, epoxy acrylate, polyester acrylate, polyurethane acrylate, epoxy methacrylate, polyester methacrylate, polyurethane methacrylate, etc.

Examples of rubbers that can configure the substrate include ethylene-propylene copolymers, ethylene-α-olefin copolymers, propylene-α-olefin copolymers, chlorinated polyethylene, saturated polyolefin based rubbers such as chlorosulfonated polyethylene, ethylene-propylene-diene copolymers, α-olefin-diene copolymers, ethylene-diene copolymers, and propylene-diene copolymers; α-olefin diene copolymer rubbers such as halides and hydrogenated products thereof, isoprene rubbers, butadiene rubbers, diene copolymer rubbers such as halides and hydrogenated products thereof, silicone based rubbers such as methyl silicone rubbers, vinyl methyl silicone rubbers, and phinyl methyl silicone rubbers; fluorine rubbers such as fluorinated silicone rubbers, fluorinated vinylidene rubbers, tetrafluoroethylene-propylene rubbers, and tetrafluoroethylene-perfluoromethyl vinyl ether rubbers; styrene-diene copolymer rubbers such as styrene-butadiene copolymers and styrene-isoprene copolymers; butyl based rubbers such as butyl rubbers and halides and hydrogenated products thereof; chloroprene based rubbers such as chloroprene rubbers and chloroprene and halides and hydrogenated products thereof; epichlorohydrin based rubbers such as epichlorohydrin rubbers and epichlorohydrin-ethylene oxide rubbers, urethane rubbers such as polyetherurethane rubbers and polyesterurethane rubbers; acrylonitrile-butadiene based rubbers such as acrylonitrile-butadiene rubbers and halides and hydrogenated products thereof; natural rubbers; and the like.

Exemplary thermoplastic elastomers include polystyrene based thermoplastic elastomers such as styrene-butadiene-styrene block copolymers, styrene-isoprene-styrene block copolymers, styrene-ethylene-butadiene-styrene block copolymers, styrene-isoprene-butadiene-styrene block copolymers, and styrene-ethylene-propylene-styrene block copolymers, and halides and hydrogenated products thereof; polyolefin based thermoplastic elastomers such as blends of olefin resins and olefin rubbers and blends of olefin resins and olefin-diene copolymers, and halides and hydrogenated products thereof; polyurethane based thermoplastic elastomers, polyester based thermoplastic elastomers, etc.

Furthermore, a crosslinking agent, polymerization initiator, filler, pigment, ultraviolet absorber, anti-aging agent, foaming agent, antifoaming agent, antioxidant, or the like can be added based on a conventional known formulation to the aforementioned polymer material configuring the substrate, depending on the material used.

The coating film formed by the coating composition of the present invention has excellent durability and can maintain tack-free properties (releasability) over a long period of time, and therefore, can be particularly preferably used as a top coating applied on a surface of a rubber product such as bladders and the like for manufacturing tires made of a rubber composition, plastic molding molds, and the like.

### Coating Film

Although the thickness of the coating film can be appropriately selected based on the application(usage) of the substrate, the part, and the like, when the coating film is used to improve the releasability of a bladder or a plastic mold (a mold made of resin) as described above, the coating film is preferably applied such that the film thickness after heat treatment is 5 μm or more, and particularly 5 to 300 μm. If the film thickness is thinner than the above range, a continuous coating film cannot be formed as compared to when the film thickness is in the aforementioned range, which may cause coating film defects and may also cause early loss of coating film performance (tack-free properties (releasability) and slipperiness) due to wear. On the other hand, even if the film thickness is thicker than the aforementioned range, further improvement in coating performance, such as releasability, cannot be expected, and thus the economic efficiency thereof is inferior.

The coating film obtained by the coating composition of the present invention formed on a surface of a substrate contains oil in the coating film at an amount of 1 to 35 wt. % and has high tack-free properties (releasability) with an n-hexadecane contact angle of 50 degrees or more, and preferably 60 degrees or more.

### EXAMPLES

### Measurement of Physical Properties

### Average Particle Diameter of Oil Particles in Coating

The obtained coating composition was dripped onto a glass slide (76×26 mm Micro slide glass, 1 to 1.2 mm thick, manufactured by Matsunami), and the slide was placed on an aluminum substrate (50 mm×100 mm, 1 mm thick) and then observed using a reflection mode of an optical microscope (KH-1300, manufactured by Hirox Co., Ltd.). Oil particles were observed using photographs taken at magnifications of 2000 to 2500 times. An average value derived from a sample size of n=20 was used as an average particle diameter. If the average particle diameter is indicated as “@” when 50 μm or less.

### Creating Test Piece

The following two types were used as the substrate.
Butyl rubber (IIR) sheet (size: 100 mm×50 mm×1 mmt (manufactured by Paltec Co., Ltd.))
Silicone rubber sheet (size: 100 mm×50 mm×1 mmt (manufactured by Paltec Co., Ltd.))
Aluminum test piece (size: 100 mm×50 mm×1 mmt, JIS A5052 compliant product)

### Substrate Surface Treatment

For the rubber substrates (butyl rubber sheet and silicone rubber sheet), surfaces were air-blown and then used as is.

An aluminum substrate was degreased using isopropyl alcohol, a sandblaster (Numablaster SGF-4(A)S-E566, manufactured by Fuji Manufacturing Co., Ltd.) was used to subject the surfaces to roughening by shot blasting using #60 alumina (Showa Blaster, manufactured by Showa Denko KK), and then wiped with isopropyl alcohol.

### Forming Coating and Coating Film

A coating was applied to the substrates using an air spray coating gun (W-88-10E2 q 1 mm nozzle (manual gun), manufactured by Anest Iwata Corporation) to spray the obtained coating composition at an air pressure of 2.5 to 3.0 kgf/cm². Test pieces were prepared by coating the coated liquid mass so as to be approximately 0.65 g (0.60 to 0.70 g) per substrate.

Note that the baking conditions are as follows.

After heating and drying at 60° C. for 10 minutes, transferring to another oven and heating at 120° C. for 10 minutes were performed, and then transferring to another oven was performed to perform a heat crosslinking treatment at 180° C. for 10 minutes.

Furthermore, transferring to another oven and heating at 120° C. for 60 minutes were performed to perform a secondary crosslinking treatment.

### Releasability Evaluation (N-Hexadecane Contact Angle)

Using the test piece obtained by the method described above, a contact angle (droplet size: approximately 2 μL) of n-hexadecane was measured using a fully automatic contact angle meter (Kyowa Interface Science Co., Ltd., DM-701) in a measurement environment of 25° C., and humidity of 60%.

### Adhesion Evaluation (Cross Cutting Test)

The surface of the coating film of the test piece obtained by the method described above was subjected to the following cross cutting test in accordance with JIS K 5600.5.6.
(1) Using a cutter knife, 11 cuts are made on the test surface to reach bare metal, and 100 grids are made. A cutter guide was used, and the interval of the cuts was 1 mm.
(2) Scotch Tape® is strongly pressed against the part of grids, an edge of the tape is peeled off at an angle of 45 degrees at once, and then the condition of the grids is evaluated by comparing with a reference diagram.

The evaluation results were displayed at the number of peeled grids (per 100 pieces).

### Stretching Test

The obtained coating composition was applied to one side of a 100 mm long, 50 mm wide, 1 mm thick butyl rubber substrate (manufactured by Paltec Co., Ltd.), and heat crosslinked at 180° C. for 10 minutes and at 120° C. for 60 minutes to form a 50 μm thick coating film. A dumbbell-shaped specimen (in accordance with ASTM D-2116) was cut out from the coated substrate, and then a stretching test was performed with a constant stretching repeated fatigue tester (MYSS Tester, H9537/H9606 manufactured by MYS-TESTER Company Limited) under the following conditions:

Measurement temperature: 200° C.; Mutation stroke: 11 mm (50% stretching); Stretching speed and return speed: 11 mm/min; Number of times stretched: 200 times. After the test was completed, the condition of the coating film was checked, and if no cracks or peeling occurred, the coating film was deemed to have passed the test.

### Raw Rubber Vulcanization Test (Hot Press)

The test piece (coated rubber substrate) obtained by the method described above was placed in a mold, a sheet of raw rubber (uncrosslinked butyl rubber) with a thickness of approximately 3 mm cut out to approximately 3 cm×10 cm was placed thereon, and then a compression molding machine (Hot Press WFA-37, manufactured by Shinto Metal Industries, Ltd., Cylinder diameter: 152 mm) was used to perform vulcanization by heating and pressurizing the sheet from above at 180° C.×2 MPa×10 minutes. After completing vulcanization, the vulcanized rubber layer was peeled off from the substrate, and then the coating condition was checked. If the substrate can be easily removed from the vulcanized rubber and the coating film does not peel off from the substrate, the evaluation was “∘”; if the rubber substrate can be removed from the vulcanized rubber but some grime remains, the evaluation was “Δ”; and if the rubber substrate cannot be removed from the vulcanized rubber or the coating film peels off from the rubber substrate, the evaluation was “x”.

### Example 1

As fluoro oil, 15.39 g of PFPE (Krytox XHT 1000 manufactured by The Chemours Company, decomposition temperature 426° C.) and 30.78 g of a fluorine based surfactant (Capstone FS-31 manufactured by The Chemours Company) were placed in a 1 liter stainless steel beaker; ultrasonic dispersion treatment was performed for 10 minutes using an ultrasonic generator (Ultrasonic MINIWELDER HS3-4 manufactured by Ultrasonic Engineering Co., Ltd.); 1.94 g of pure water and 189.94 g of a FEP aqueous dispersion (Teflon® FEP 120-JR manufactured by Chemours-Mitsui Fluoroproducts Co., Ltd. (FEP resin solid fraction: 54.5 wt. %) as fluorine resin particles were added and stirred for 10 minutes at 200 rpm using a downflow type propeller type 4-bladed stirrer; and then 250.63 g a hydrogenated acrylonitrile butadiene rubber dispersion (Zetpol® 2230LX manufactured by ZEON Corporation (HNBR solid fraction: 40.6 wt. %)) was added and then further stirred for 5 minutes at 150 rpm. 9.02 g of a 10 wt. % methylcellulose aqueous solution and 2.3 g of a silane coupling agent (KBM-603 manufactured by Shin-Etsu Chemical Co., Ltd.) were added thereto and then stirred at 250 rpm for 15 minutes to obtain a coating composition.

### Examples 2 and 3

Paint compositions were prepared in the same manner as in Example 1 with the exception that the fluoro oil content was set to the proportions shown in Table 1.

### Example 4

A coating composition was prepared with the same content ratio as in Example 1, except that a PFA aqueous dispersion (Teflon® PFA 334-JR manufactured by Chemours-Mitsui Fluoroproducts Co., Ltd. (PFA resin solid fraction: 60 wt. %)) was used as the fluorine resin particles.

### Example 5

A coating composition was prepared in the same manner as in Example 4 with the exception that the fluoro oil content was set to the proportion shown in Table 1.

### Example 6

A coating composition was prepared with the same content ratio as in Example 1, except that a PTFE aqueous dispersion (Teflon® PTFE 34-JR manufactured by Chemours-Mitsui Fluoroproducts Co., Ltd. (PTFE resin solid fraction: 58 wt. %)) was used as the fluorine resin particles.

### Example 7

A coating composition was prepared in the same manner as in Example 2, except that no silane coupling agent was used.

### Example 8

6.15 g of PFPE (Krytox XHT-1000 manufactured by the Chemours Company) as fluoro oil was placed in 12.3 g of a fluorine based surfactant (Capstone FS-31 manufactured by The Chemours Company) and then subjected to an ultrasonic dispersion treatment for 10 minutes. The mixed composition liquid was placed in a liquid mixture of 45.78 g of pure water and 182.97 g of an FEP aqueous dispersion liquid (Teflon® FEP 120-JR manufactured by Chemours-Mitsui Fluoroproducts Co., Ltd. (FEP resin solid fraction: 54.5 wt. %)), and then stirred for 10 minutes at 200 rpm using a downflow type propeller type 4-bladed stirrer. 241.44 g of a silicone rubber dispersion (KM-2002-T manufactured by Shin-Etsu Chemical Co., Ltd. (silicone rubber solid fraction: 40 wt. %)) was added and then further stirred at 200 rpm for 5 minutes. Next, 4.34 g of a 10 wt. % methylcellulose aqueous solution and 7.01 g of a black pigment (CB 853-4297 manufactured by The Chemours Company) were added to the mixture and stirred at 250 rpm for 15 minutes to obtain 500 g of a coating composition.

### Examples 9 and 10

Coating compositions were prepared in the same manner as in Example 7, except that the mixing ratio of silicone rubber and fluorine resin particles was set to the ratio shown in Table 1.

### Comparative Example 1

A coating composition was prepared so as to have the same content ratio as in Example 1, except that fluoro oil was not used.

### Comparative Example 2

A coating composition was prepared in the same manner as Comparative Example 1 with the composition ratio shown in Table 1, without using fluoro oil and fluorine resin particles.

### Comparative Example 3

A coating composition was prepared in the same manner as Example 10 with the composition ratio shown in Table 1, without using fluoro oil

TABLE 1

| | | | | | | | | Silane | |
|---|---|---|---|---|---|---|---|---|---|
| | Rubber | | Rubber | | | | | coupling | |
| | (weight parts) | | solid | Fluorine resin particles | | | Oil | agent | |
| | | Silicone | fraction | (weight parts) | | | (weight | (weight | Oil |
| | HNBR | rubber | (wt. %) | FEP | PFA | PTFE | parts) | parts) | dispersibility |
| Example 1 | 50 | | 20.3 | 50 | | | 7 | 1.1 | ⊚ |
| Example 2 | 50 | | 21.1 | 50 | | | 3 | 1.1 | ⊚ |
| Example 3 | 50 | | 16.5 | 50 | 50 | | 20 | 1.1 | ⊚ |
| Example 4 | 50 | | 21.1 | | 50 | | 7 | 1.1 | ⊚ |
| Example 5 | 50 | | 18.4 | | | 50 | 15 | 1.1 | ⊚ |
| Example 6 | 50 | | 20.7 | | | | 7 | 1.1 | ⊚ |
| Example 7 | 50 | | 21 | 50 | | | 3 | — | ⊚ |
| Example 8 | | 50 | 19.3 | 50 | | | 3 | 1.1 | ⊚ |
| Example 9 | | 90 | 27.4 | 10 | | | 10 | 1.1 | ⊚ |
| Example 10 | | 100 | 29.7 | — | | | 10 | 1.1 | ⊚ |
| Comparative | 50 | | 21.9 | 50 | | | — | 1.1 | — |
| Example 1 | | | | | | | | | |
| Comparative | 100 | | 37.4 | — | | | — | 1.1 | — |
| Example 2 | | | | | | | | | |
| Comparative | | 100 | 32.4 | — | | | — | 1.1 | — |
| Example 3 | | | | | | | | | |

| | | | N-hexadecane contact angle | | | | Raw rubber | |
|---|---|---|---|---|---|---|---|---|
| | Cross cutting test | | (°) | | | | vulcanization test | |
| | | Silicone | | | Silicone | Extension | | Silicone |
| | IIR | rubber | AI | IIR | rubber | test IIR | IIR | rubber |
| | substrate | substrate | substrate | substrate | substrate | substrate | substrate | substrate |
| Example 1 | 2/100 | | 54.5 | | | | ◯ | |
| Example 2 | 0/100 | | 67.1 | | | Pass | ◯ | |
| Example 3 | 0/100 | 100/100 | 64.9 | 60.5 | 57.4 | Pass | ◯ | X |
| Example 4 | 0/100 | | 65.2 | | | | ◯ | |
| Example 5 | 0/100 | 100/100 | 55.2 | 55.7 | 51.8 | Pass | ◯ | X |
| Example 6 | 2/100 | | 62.1 | | | | Δ | |
| Example 7 | 18/100 | | 66.7 | | | Pass | Δ | |
| Example 8 | 0/100 | | 56.9 | | | Pass | ◯ | |
| Example 9 | 0/100 | 0/100 | 35.1 | | | Pass | ◯ | ◯ |
| Example 10 | 0/100 | 0/100 | 34.7 | 38.5 | 38.7 | Pass | ◯ | ◯ |
| Comparative | 0/100 | | 45.3 | | | | Δ | |
| Example 1 | | | | | | | | |
| Comparative | 100/100 | | 9.5 | | | | X | |
| Example 2 | | | | | | | | |
| Comparative | 100/100 | | 30.7 | | | | X | |
| Example 3 | | | | | | | | |

1. A coating composition, comprising:
a rubber; and
an oil that is a liquid at 25° C., wherein
the oil is dispersed at an average particle diameter of 50 μm or less.

2. The coating composition according to claim 1, further comprising fluorine resin particles.

3. The coating composition according to claim 1, further comprising a silane coupling agent.

4. The coating composition according to claim 2, wherein the oil is included at an amount of 1 to 35 wt. % of the amount (solid fraction) in the coating composition or the total amount (solid fraction) of the rubber and the fluorine resin particles.

5. The coating composition according to claim 2, wherein the rubber is included at an amount of 40 wt. % or more of the total amount (solid fraction) of the rubber and the fluorine resin particles in the coating composition.

6. The coating composition according to claim 1, wherein the rubber is a hydrogenated acrylonitrile butadiene rubber or silicone rubber.

7. The coating composition according to claim 1, wherein the oil is a fluoro oil or silicone oil.

8. The coating composition according to claim 2, wherein the fluorine resin particles comprise melt-processable fluorine resin.

9. The coating composition according to claim 8, wherein the fluorine resin particles comprise PFA or FEP.

10. A rubber or plastic substrate having a coating film made of the coating composition according to claim 1 on a surface, wherein the oil is dispersed in the coating film.

11. The rubber or plastic substrate according to claim 10, wherein the n-hexadecane contact angle of the coating film is 50 degrees or more.
